(19) United States
(12) Patent Application Publication
(10) Pub. No.: US 2007/0157983 A1
(43) Pub. Date: Jul. 12, 2007

(54) Arrangement for cooling the exhaust gas of a motor vehicle

(75) Inventors: Claus Beck, Esslingen (DE); Peter Geskes, Ostfildern (DE); Damien Henon, Muhlacker (DE)

Correspondence Address: FOLEY AND LARDNER LLP;SUITE 500, 3000 K STREET NW, WASHINGTON, DC, 20007, US

(73) Assignee: BEHR GmbH & CO. KG, Stuttgart (DE)

(21) Appl. No.: 10/587,755

(22) PCT Filed: Feb. 3, 2005
(86) PCT No.: PCT/EP05/01057

§ 371 Date: Jul. 28, 2006

(30) Foreign Application Priority Data
Feb. 9, 2004 (DE) 10 2004 006 357.5

(51) Int. Cl. F16K 1/16

(52) U.S. Cl. 137/875

(57) ABSTRACT

The invention relates to an arrangement (1) for cooling exhaust gas, said arrangement comprising a housing (2) containing a heat transfer region (5), an actuator for regulating the flow of exhaust gas through the heat transfer region (5). and/or a bypass channel (6). Said housing (2) is embodied as a single component in the longitudinal direction of the inventive arrangemnent (1), and the actuator is arranged in the housing (2).

The invention relates to an arrangement for cooling the exhaust gas of a motor vehicle, according to the preamble of claim 1.

DE 199 62 863 A1 discloses an exhaust-gas cooler for transferring heat between the exhaust gas from an internal combustion engine of a motor vehicle and a coolant, said exhaust-gas cooler having a housing which is made up of two or more parts and comprises an exhaust-gas inlet region, a heat-transfer region, a bypass duct which runs parallel to said heat-transfer region and is arranged in the housing, and an exhaust-gas outlet region. In this case, an actuating element for controlling the flow of exhaust gas through the heat-transfer region and/or the bypass duct is provided in the exhaust-gas outlet region which is attached to the heat-transfer region.

An arrangement for cooling exhaust gas of this type leaves something to be desired, amongst other things in terms of production costs.

The object of the invention is to improve an arrangement for cooling exhaust gas of the type mentioned in the introduction.

This object is achieved by an arrangement for cooling exhaust gas having the features of claim 1.

According to the invention, an arrangement for cooling exhaust gas is provided with a housing containing a heat-transfer region, an actuating element for controlling the flow of exhaust gas through the heat-transfer region and/or a bypass duct, wherein the housing is integrally formed in the longitudinal direction of the arrangement for cooling exhaust gas, and the actuating element is arranged in that region of the housing which is integrally formed in the longitudinal direction. In this case, the housing may be divided in the longitudinal direction, in particular centrally in the longitudinal direction, in order to simplify mounting.

The actuating element is preferably in the form of a flap, with the shaft and the flap part preferably being formed separately in order to allow mounting in a laterally closed, integral housing, and being connected, in particular welded or soldered, to one another after installation.

The actuating element may be arranged either in the exhaust-gas inlet region or in the exhaust-gas outlet region, with arrangement in the exhaust-gas inlet region being preferred.

The housing preferably contains the heat-transfer region, an exhaust-gas inlet region and/or an exhaust-gas outlet region. A diffuser region may also be part of the housing here. As an alternative, particularly in the case of an integral design of the housing without division in the longitudinal direction, a diffuser region may be attached, preferably welded or soldered, to the housing.

The bypass duct is preferably arranged in the housing such that it runs parallel to the heat-transfer region. As an alternative, the bypass duct may also branch off in the exhaust-gas inlet region and run outside the housing.

The invention is explained in detail in the text which follows using three exemplary embodiments with reference to the drawing, in which

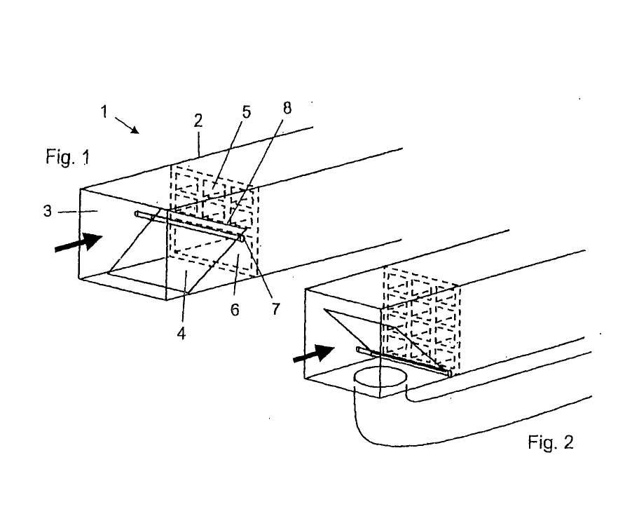

FIG. 1 schematically shows a detail of an arrangement for cooling exhaust gas according to the first exemplary embodiment,

FIG. 2 schematically shows a detail of an arrangement for cooling exhaust gas according to the second exemplary embodiment, and

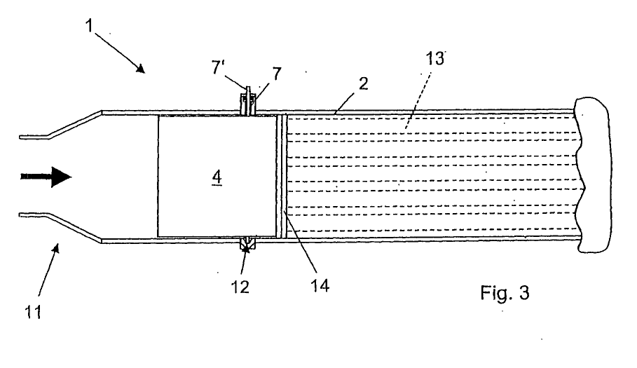

FIG. 3 shows a longitudinal section through an arrangement for cooling exhaust gas according to the third exemplary embodiment.

FIG. 1 shows an arrangement 1 for cooling exhaust gas, having a housing 2, an exhaust-gas inlet region 3 which contains a flap 4 as an actuating element for controlling the flow of exhaust gas (indicated by an arrow), a heat-transfer region 5 which adjoins said exhaust-gas inlet region, and a bypass duct 6 which is arranged parallel to said heat-transfer region. The exhaust-gas outlet region (not illustrated) is formed in a corresponding manner, but without the actuating element.

The flap 4 can be pivoted about a pivot shaft 7, with the pivot shaft 7 being arranged adjacent and parallel to a partition wall 8 between the heat-transfer region 5 and the bypass duct 6 which run parallel to one another, so that the flap 4 guides the flow of exhaust gas as a function of its position, namely either to the heat-transfer region 5 or to the bypass duct 6 in the respective end positions and correspondingly distributed between the heat-transfer region 5 and the bypass duct 6 in intermediate positions.

The housing 2 is integrally formed over the entire region, so that it assimilates the flap function and the heat-transfer function and, at present, the bypass function too. Mounting is carried out from an open end of the housing 2, with positioning and fixing being carried out by means of stops and/or openings which are provided in the housing 2 and are tightly closed after mounting. Other elements, for example a diffuser at the exhaust-gas inlet, are attached after mounting.

According to one modification of the first exemplary embodiment, the housing 2 is centrally divided in the longitudinal direction, so that the housing 2 can be produced in a simpler manner and the installed components, such as the flap 4, heat-transfer region 5 and bypass duct 6 in particular, can be mounted in a simpler manner. Following assembly, the two housing halves which form the housing 2 are welded or soldered. The two housing halves themselves are not divided in the longitudinal direction, that is to say they are each integrally formed in the longitudinal direction from the exhaust-gas inlet region 3 to the exhaust-gas outlet region. In this case, a diffuser may also be integrally formed with the housing 2 as a result of simpler mounting, so that each housing half comprises a diffuser half. The same also applies to the exhaust-gas outlet region.

According to the second exemplary embodiment, the heat-transfer region 5 takes up the entire cross section of the housing 2 and a bypass duct 6 is provided which runs outside the housing 2 and branches off from the housing 2 upstream of the flap 4. In this case, the pivot shaft 7 of the flap 4 is arranged in the region of a wall of the housing 2, with the flap 4 being arranged substantially perpendicular to the longitudinal axis of the housing and upstream of the heat-transfer region 5 in one end position, and being arranged substantially parallel to the longitudinal axis of the housing and upstream of the outlet opening to the bypass duct 6 in its other end position. The bypass duct 6 is again introduced into the housing 2 downstream of the heat-transfer region 5, in accordance with the branch illustrated in FIG. 2.

In accordance with the third exemplary embodiment which is illustrated in FIG. 3, a diffuser 11 which is subsequently attached to the housing and serves to expand the flow of exhaust gas is additionally provided. A flap 4 for controlling the flow of exhaust gas and distributing the latter to a heat-transfer region 5 and a bypass duct (not illustrated), which runs parallel to said heat-transfer region in accordance with the first exemplary embodiment, is arranged downstream of said diffuser, with the flap 4 having a shaft 7′ which protrudes through a shaft bushing with a seal and is mounted on the other housing side in a bearing 12, with the bearing 12 being formed by a small deformation of the housing 2 on the outside. The part of the flap 4 which controls the flow of exhaust gas and at present is substantially formed in the manner of a plate is welded to the shaft 7′ following mounting. In order to position the heat-transfer region 5 with its individual cooling pipes 13 and to position the bypass duct in the housing 2, a base 14 is provided which forms a stop for this purpose.

### List of Reference Symbols

1 Arrangement for cooling exhaust gas
2 Housing
3 Exhaust-gas inlet region
4 Flap
5 Heat-transfer region
6 Bypass duct
7 Pivot shaft
7′ Shaft
8 Partition wall
11 Diffuser
12 Bearing
13 Cooling pipe
14 Base

1. An arrangement for cooling exhaust gas, having a housing containing a heat-transfer region, and an actuating element for controlling the flow of exhaust gas through the heat-transfer region and/or a bypass duct, wherein the housing is integrally formed in the longitudinal direction of the arrangement for cooling exhaust gas, with the actuating element being arranged in the housing.

2. The arrangement for cooling exhaust gas as claimed in claim 1, wherein the actuating element is in the form of a flap.

3. The arrangement for cooling exhaust gas as claimed in claim 2, wherein the flap has two or more parts, with a shaft which forms the pivot shaft of the flap being formed separately from the part of the flap which controls the flow of exhaust gas, and said part of the flap being attached to the shaft after said shaft is mounted.

4. The arrangement for cooling exhaust gas as claimed in claim 3, wherein the part of the flap which controls the flow of exhaust gas is attached to the shaft by means of welding or hot-soldering or compression.

5. The arrangement for cooling exhaust gas as claimed in claim 1 wherein the actuating element is arranged in the exhaust-gas inlet region or in the exhaust-gas outlet region.

6. The arrangement for cooling exhaust gas as claimed in claim 1 wherein the bypass duct is arranged in the housing.

7. The arrangement for cooling exhaust gas as claimed in claim 1 wherein the bypass duct branches off in the exhaust-gas inlet region.

8. The arrangement for cooling exhaust gas as claimed in claim 1 wherein the housing is integrally formed.

9. The arrangement for cooling exhaust gas as claimed in claim 8, wherein the housing contains the heat-transfer region, an exhaust-gas inlet region and/or an exhaust-gas outlet region.

10. The arrangement for cooling exhaust gas as claimed in claim 1 wherein the housing is composed of two half-shells (the housing is divided in the longitudinal direction).

11. The arrangement for cooling exhaust gas as claimed in claim 1 wherein the exhaust gas is diverted in the cooler.

12. The arrangement for cooling exhaust gas as claimed in claim 1 wherein the housing has openings through which the flap is fixed to the pivot shaft and this mounting opening is later closed again.
